(19) United States
(12) Patent Application Publication
(10) Pub. No.: US 2022/0016736 A1
(43) Pub. Date: Jan. 20, 2022

(54) MACHINE TOOL WITH LOADING DEVICE

(71) Applicant: Thielenhaus Technologies GmbH, Wuppertal (DE)

(72) Inventor: Rudolf Schwär, Müllheim-Vögisheim (DE)

(21) Appl. No.: 17/312,385

(22) PCT Filed: Jan. 28, 2020
(86) PCT No.: PCT/EP2020/052008

§ 371 Date: Jun. 9, 2021

(30) Foreign Application Priority Data
Jan. 29, 2019 (DE) 10 2019 102 139.1

(51) Int. Cl. B23Q 7/02; B23Q 7/04

(52) U.S. Cl. CPC B23Q 7/02; B23Q 2707/04; B23Q 7/046; B23Q 7/048

(57) ABSTRACT

The present invention relates to a machine tool for machining surfaces of in particular rotationally symmetrical workpieces (7), comprising
at least one machining station (1, 2),
at least one loading station (3) and/or unloading station (4) for the workpieces to be machined and/or the machined workpieces,
a loading device (6) for transferring the workpieces (7) from one station (1, 2, 3, 4) to an adjacent station (1, 2, 3, 4),

characterized in that the loading device (6) comprises
a rotatably driven sliding device (8),
a drive (9) for the sliding device (8) and
a rotatably mounted and braked guiding device (10),

wherein driving the sliding device (8) initially causes a workpiece (7) to be pressed by the sliding device (8) against the guiding device (10), after which the workpiece (7) abutting against the sliding device (8) and abutting against the braked guiding device (10) indirectly moved by the sliding device (8) is transferred onto a circular arc track from one station (1, 2, 3, 4) into an adjacent station (1, 2, 3, 4).

The present invention relates to a machine tool for machining surfaces of in particular rotationally symmetrical and preferably metallic workpieces, comprising at least one machining station, at least one loading station and/or unloading station for the to be machined or machined workpieces, and a loading device for transferring the workpieces from one station to an adjacent station.

In such a machine tool, the workpieces to be machined are usually guided on a transport track to the loading station, in which the loading device grips the workpiece. To this end, the loading device usually has at least two respectively actively driven gripping elements. The workpiece is then lifted by the loading device from the loading station, and usually moved over a centering roller into a machining station, where the loading device lowers the workpiece onto a rotatably drivable workpiece holder. The gripping elements are moved out of the machining station while the workpiece is being machined in the machining station. After machining, the gripping elements of the loading device grip the workpiece again, lift it up, and transfer it into another machining station or into the unloading station. From the unloading station, the workpiece can then be transported by means of the transport track out of the machine tool. The gripping, lifting, and lowering of the workpieces makes the setup time for the machining stations relatively long. In addition, the actively generated movements of the several gripping elements for gripping a workpiece must be synchronized with a relatively high effort in terms of device and control technology.

Therefore, the object of the present invention is to solve the problems described with respect to prior art, and in particular to indicate a machine tool in which the setup time for the machine tool is shortened with a simple effort in terms of device technology.

The object is achieved by a machine tool with the features of the independent claim. Advantageous further developments of the machine tool are indicated in the independent claims and in the specification, wherein individual features of the advantageous further developments can be combined with each other as desired in a technically useful manner.

In particular, the object is achieved by a machine tool with the features mentioned at the outset, in which the loading device comprises a rotatably driven sliding device, a drive for the sliding device, a rotatably mounted guiding device, and a brake for the guiding devices, wherein driving the sliding device initially causes a workpiece to be pressed by the sliding device against the guiding device, after which the workpiece abutting against the sliding device and abutting against the braked guiding device indirectly moved by the sliding device is transferred onto a circular arc track from one station into an adjacent station.

The basic idea of the invention thus provides that only one device has to be driven to grip the workpiece, which clamps the workpiece between itself and the not actively directly driven guiding device for transferring the workpiece.

Therefore, only one drive need to be provided for the sliding device, which rotatably drives the sliding device. By contrast, the guiding device need only be rotatably mounted, and designed in such a way that the workpiece is pressed by the sliding device against the guiding device. As a consequence, no separate drive, and thus no mechanical or electronic controller, is required for coupling the sliding device with the guiding device. The workpiece can hence be easily and quickly transferred from one station (for example, machining station, loading station, or unloading station) to an adjacent station.

In an embodiment, the movement path traversed by the workpiece takes the form of a circular arc in a horizontal plane, so that the workpiece is not lifted during the transfer from one station to an adjacent station. In such an embodiment, it can be provided that the machining station comprise a centering roller, which is lowered while transferring the workpiece from one station to an adjacent station.

While transferring the workpiece in a horizontal plane, the workpiece as a rule rests on a support surface of the machine tool. To allow the machine tool to be used for different workpieces, the support surface can have at least one recess, for example in which at least one centering roller or another element can be arranged for mounting/guiding the workpiece during machining in the machining station. The recess is dimensioned so as to allow the centering roller to be arranged in various positions relative to the machining station when a workpiece with other than previous geometric dimensions is to be machined. So that the workpieces can be transferred from one station to an adjacent station even with the centering roller overlying in various positions, it can be provided that a support element can be fixed in the recess in various positions, so that the support element at least partially closes the recess, and the workpiece at least temporarily rests on the support element in the area of the recess during the transfer.

In order not to have to lower the centering roller of the machining station in an alternative embodiment, it can also be provided that the driven sliding device and the braked guiding device perform an axial up and down movement while transferring the workpiece, as a result of which the workpiece is lifted during the transfer and then lowered again. Viewed from the top, the workpiece thus continues to perform a circular arc movement during the transfer, while the workpiece also performs an up and down movement in the vertical direction. In this way, the workpiece can be lifted by elements arranged between the stations.

In order for the sliding device and guiding device to perform an up and down movement during the rotational movement, in particular cam (pairs) are provided, which run over each other during the rotational movement of the sliding device and guiding device, so that the devices perform an up and down movement, in particular together in the vertical direction. This passively generated up and down movement makes it possible to lift the workpiece without any additional drive for the up and down movement. In this case, the sliding device and guiding device are thus not only rotatable, but also mounted in an axially movable manner for the order of magnitude required for the up and down movement needed for lifting purposes.

The sliding device and guiding device are preferably designed in such a way that several (at least two) workpieces can be simultaneously transferred from different stations to a respectively adjacent station.

In particular, the machine tool has a loading station and additionally an unloading station, as well as at least one machining station, preferably at least or exactly two or even at least three machining stations.

In particular, it is provided that the sliding device and guide device each have a preferably integral loading cross with several arms, wherein the number of arms corresponds to the number of stations of the machine tool. As a consequence, several workpieces can thus be transferred from different stations to a respective adjacent station. The loading crosses preferably extend in a horizontal plane.

Preferably secured to each arm of the sliding device is an element also referred to as a slider, which is in contact with the workpiece during the transfer of the workpiece. This slider is preferably designed in such a way that it only comes to abut against the rotationally symmetrical workpiece at a punctiform or line-shaped contact place. In this way, it is possible to use a slider for different workpiece dimensions and/or geometries, since the slider need not be adjusted to the workpiece geometry given its punctiform or linear abutment.

For the abutment of the workpiece, the guiding device preferably comprises a respective receiving prism, which in particular is mounted on the arm of the guiding device, wherein the receiving prism comes to abut against the workpiece at precisely two punctiform or line-shaped contact places. In particular, such a receiving prism has two support surfaces arranged at an angle relative to each other, so that the receiving prism can be used in particular for various workpieces that differ in terms of their diameter.

The receiving prism is preferably pivotably mounted to the arm of the guiding device, so that the receiving prism can assume different pivoting positions depending on the diameter of the workpiece to be transferred. In combination with the slider that comes to abut against the workpiece on only a point or a line, a specific three-point system that adjusts itself to the workpiece is thus provided, which can be used for different workpieces independently of the dimensions of the workpieces. Therefore, the loading device need not be converted at a high cost when retooling the machine tool to machine workpieces with other dimensions. In particular, a receiving prism is arranged on each arm of the guiding device.

In particular, the receiving prism is pivotably mounted by means of two arc-shaped oblong holes, wherein a respective pin engages into each oblong hole. The oblong holes can be directly formed in the receiving prism, while the pins are formed on the respective arm. A reverse arrangement is also possible. This yields a simple pivot bearing, wherein the oblong holes or the pins are eccentrically arranged on the receiving prism.

The loading cross of the sliding device is preferably coupled directly with a drive shaft of an electric motor as the drive for the sliding device, so that the rotation of the drive shaft is preferably converted directly into a rotational movement of the loading cross. The rotational movement of the loading cross of the sliding device is initially decoupled from the loading cross of the guiding devices. Only when the loading cross of the guiding device is indirectly driven by the workpiece arranged between the loading cross of the sliding device and the loading cross of the guiding device does a movement of the loading cross of the guiding device take place. In a preferred embodiment, the loading cross of the sliding device is arranged above or below the loading cross of the guiding device.

The brake of the guiding device is designed in such a way that the guiding device accelerated by the sliding device comes to an immediate stop without any continued acceleration by the sliding device. For example, the braking device can be designed as a disc spring brake, which acts on the loading cross of the guiding device.

The at least one machining station is preferably set up for finishing, which is also known as finish or microfinish machining. In particular, the machining station has a rotatably drivable workpiece holder and a tool holder, wherein the tool holder and workpiece holder can preferably perform an oscillating movement relative to each other, which in particular is aligned transverse to the rotational movement of the workpiece or parallel to the rotational axis of the workpiece. This enables a so-called long-stroke and/or short-stroke machining of the workpiece. In particular, radially aligned inner or outer surfaces of the workpiece are machined by means of tools. In particular, the machining stations can be set up for machining rolling bearing rings. The tools used for finish machining have geometrically indeterminate cutting edges, in which the cutting materials are bound in a binding material.

The invention as well as the technical environment will be exemplarily described below based on the figures. Shown schematically on the figures are:

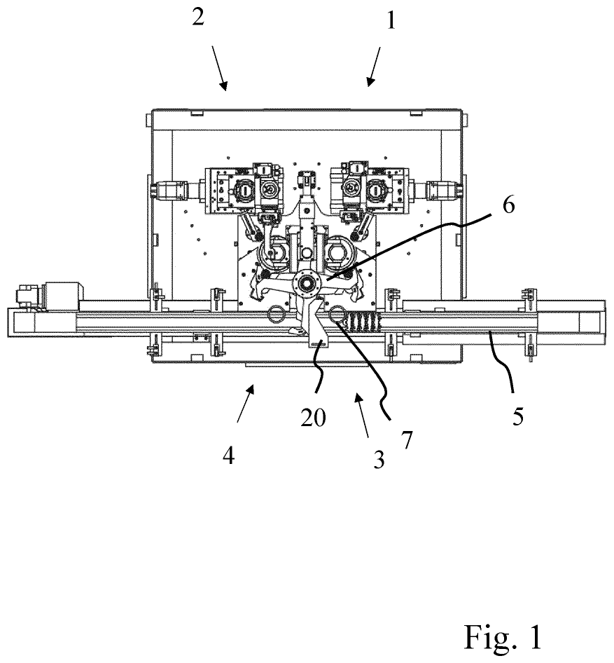

FIG. 1: a top view of the machine tool, position,

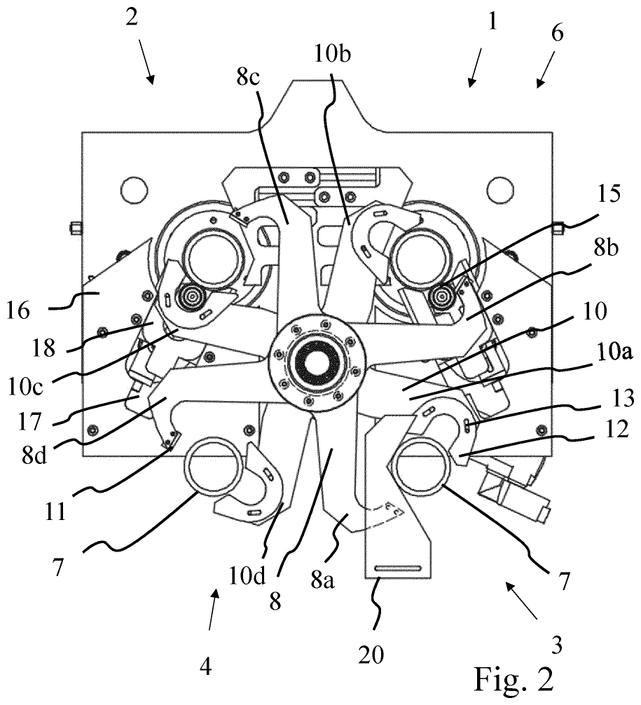

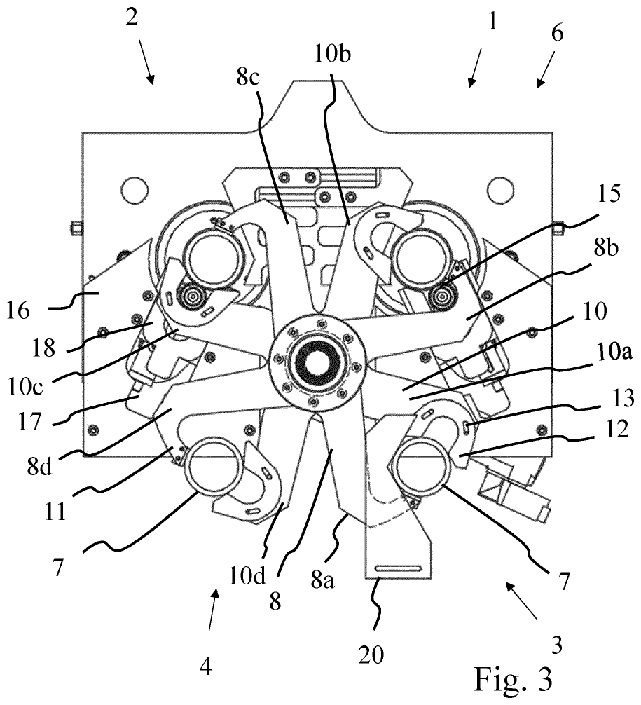

FIG. 3: the top view according to FIG. 2 in a clamping position, and

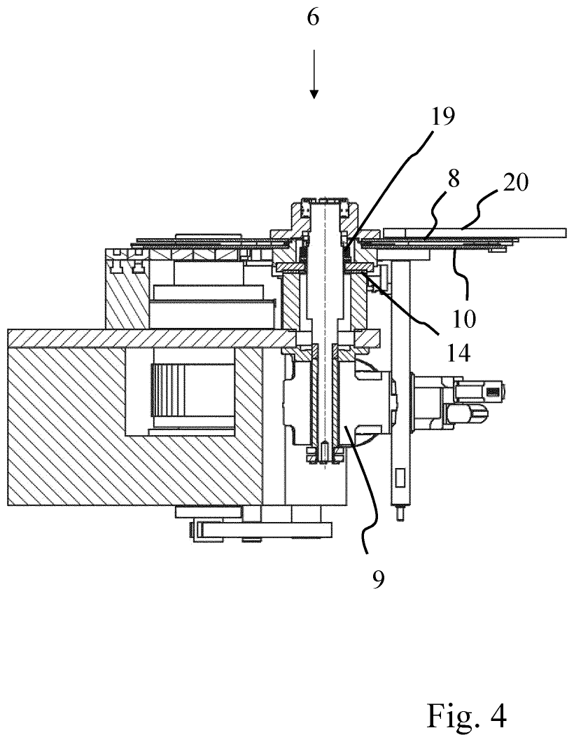

FIG. 4: a vertical sectional view through the machine tool.

The machine tool shown in the figures comprises a first machining station 1, a second machining station 2, a loading station 3 and an unloading station 4, wherein the workpieces 7 to be machined are transported by means of a transport track 5 to the loading station 3, and the machined workpieces 7 are transported from the transport track 5 out of the machine tool. A stop prism 20 is provided to hold the workpieces 7 supplied from the transport track 5 in the loading station 3.

The machine tool further comprises a loading device 6, which is shown in detail and in different positions in FIGS. 2 and 3.

The loading device 6 comprises a sliding device 8 designed as a loading cross with four arms 8a, 8b, 8c, 8d. The loading device 6 further comprises a guiding device 10 likewise designed as a loading cross with four arms 10a, 10b, 10c, 10d. A slider 11 is arranged on each arm 8a, 8b, 8c, 8d of the sliding device, while a receiving prism 12 is arranged on each arm 10a, 10b, 10c, 10d of the guiding device 10. The respective receiving prism 12 is pivotably mounted on the respective arm 10a, 10b, 10c, 10d of the guiding device 10 by means of two arc-shaped oblong holes 13.

The machine tool additionally has support surfaces 16, in which recesses 17 are formed. Arranged in the recesses 17 are support elements 18, which can be fixed in various positions.

In addition, the machining stations 1 and 2 each have a centering roller 15.

As evident in particular from FIG. 4, the sliding device 8 is actively driven by means of a drive 9, while the rotatably mounted guiding device 10 is passively braked by means of a brake 19, for example one designed as a disc spring brake. Cams 14 can be formed between the guiding device 10 and a sleeve surrounding the drive shaft of the drive 9, which cause an up and down movement of the sliding device 8 and guiding device 10 during the rotational movement.

Now shown on FIG. 2 is a loading position of the loading device 6, in which the arms 8a, 8b, 8c, 8d with their sliders 11 or the arms 10a, 10b, 10c, 10d with their receiving prisms 12 are spaced apart from the respective workpiece 7. In order to grip the workpieces 7, exclusively the sliding device 8 is now driven by means of the drive 9, as a result of which the respective workpiece 7 is initially pressed by the slider 11 of the respective arm 8a, 8b, 8c, 8d against the receiving prism 12 of the respective arm 10a, 10b, 10c, 10d of the guiding device 10. The slider 11 and respective prism 12 define three punctiform or linear abutment places, so that the workpiece 7 is definitely clamped. An additional drive of the sliding device 8 transfers the respective workpiece 7 counterclockwise on a circular arc track into the next station, wherein the sliding device 8 and guiding device 10 are together moved up and down by the cams 14 running one over the other, as a result of which the workpieces 7 are raised, and hence lifted via the centering rollers 15.

Alternatively, it would be possible to lower the centering rollers 15 while transferring the workpieces.

While transferring the workpieces 7 to adjacent stations, the guiding device 10 is only indirectly driven by the sliding device 8, wherein the braking force caused by the brake 19 is overcome. After the drive 9 by the sliding device 8 has ended, the guiding device 10 remains in its position previously prescribed by the sliding device 8.

After reaching the next station, the sliding device 8 is driven in opposite directions, so that the workpieces 7 are released. After the workpieces 7 have been machined in the machining stations 1 and 2, a new loading and unloading process follows.

The present invention enables an easy transfer of the workpieces from one station to an adjacent station with short setup times.

### REFERENCE LIST

1 First machining station
2 Second machining station
3 Loading station
4 Unloading station
5 Transport track
6 Loading device
7 Workpiece
8 Sliding device
8a, 8b, 8c, 8d Arms
9 Drive
10 Guiding device
10a, 10b, 10c, 10d Arms
11 Slider
12 Receiving prism
13 Oblong hole
14 Cam
15 Centering roller
16 Support surface
17 Recess
18 Support element
19 Brake
20 Stop prism

1. A machine tool for machining surfaces of in particular rotationally symmetrical workpieces (7), comprising
at least one machining station (1, 2),
at least one loading station (3) for the workpieces (7) to be machined and/or an unloading station (4) for the machined workpieces,
a loading device (6) for transferring the workpieces (7) from one station (1, 2, 3, 4) to an adjacent station (1, 2, 3, 4),
characterized in that the loading device (6) comprises
a rotatably driven sliding device (8),
a drive (9) for the sliding device (8),
a rotatably mounted guiding device (10), and
a brake (19) for the guiding device,
wherein driving the sliding device (8) initially causes a workpiece (7) to be pressed by the sliding device (8) against the guiding device (10), after which the workpiece (7) abutting against the sliding device (8) and abutting against the braked guiding device (10) indirectly moved by the sliding device (8) is transferred onto a circular arc track from one station (1, 2, 3, 4) into an adjacent station (1, 2, 3, 4).

2. The machine tool according to claim 1, wherein the sliding device (8) and guiding device (10) each have several arms (8a, 8b, 8c, 8d and 10a, 10b, 10c, 10d).

3. The machine tool according to claim 1, wherein the sliding device (8) can be made to abut against the rotationally symmetrical workpiece (7) at exactly one punctiform or line-shaped contact place.

4. The machine tool according to claim 1, wherein the guiding device (10) has at least one arm (10a, 10b, 10c, 10d) and one receiving prism (12) mounted on the arm (10a, 10b, 10c, 10d), wherein the receiving prism (12) can be made to abut against the rotationally symmetrical workpiece (7) at exactly two punctiform or line-shaped contact place.

5. The machine tool according to claim 4, wherein the receiving prism (12) is pivotably mounted on the arm (10a, 10b, 10c, 10d) of the guiding device (10).

6. The machine tool according to claim 5, wherein the pivot bearing of the receiving prism (12) is realized by at least two oblong holes (13).

7. The machine tool according claim 1, wherein the sliding device (8) and/or guiding device (10) are set up in such a way that the workpiece (7) is lifted during a transfer.

8. The machine tool according to claim 7, wherein cams (14) are provided for generating an up and down movement of the sliding device (8) and guiding device (10).

9. The machine tool according to claim 1, wherein the at least one machining station (1, 2) comprises a centering roller (15), and wherein the centering roller (15) can be lowered.

10. The machine tool according to claim 1, wherein at least one support surface (16) for the workpiece (7) is formed between two adjacent stations (1, 2, 3, 4) during the transfer, and wherein the support surface (16) has at least one recess, in which a support element (18) fixable in different positions is arranged.

11. The machine tool according to claim 2, wherein the sliding device (8) can be made to abut against the rotationally symmetrical workpiece (7) at exactly one punctiform or line-shaped contact place.
